(19) United States
(12) Patent Application Publication
(10) Pub. No.: US 2003/0031304 A1
(43) Pub. Date: Feb. 13, 2003

(54) Telephone device for remote selection of a menu function

(76) Inventors: David J T Heatley, Felixstowe (GB); Robert EV Semos, Sidcup (GB)

Correspondence Address: Nixon & Vanderhye, 8th Floor, 1100 North Glebe Road, Arlington, VA, 22201-4714, US

(21) Appl. No.: 10/221,603

(22) PCT Filed: Mar. 21, 2001
(86) PCT No.: PCT/GB01/01255

(51) Int. Cl. H04M 1/64

(52) U.S. Cl. 379/77; 379/88.24

(57) ABSTRACT

A mobile telephone network detects that a caller has dialed a called user's previously assigned network number, and automatically sends the caller a Phone Update command comprising the sequence corresponding to the caller's telephone. The network obtains the correct sequence for that caller's telephone from a mapping of equipment type against menu structure type, and all users have an equipment identifier entry in their profiles. The Phone Update command also includes the called user's new number, and the control unit enters this in the appropriate place of the Add Entry submenu function ready for the user to accept.

The control unit checks whether the caller used his Phonebook to make the call, and if so enters the Phonebook Edit function, ready for the user to accept replacement of the existing stored number by the number newly received in the Phone Update command.

A called telephone uses received CLI to check whether caller details are already in the Phonebook. If not, the control unit enters Add Entry function and sends a command to the network requesting name data associated with that CLI.

The present invention relates to communications methods and apparatus, and particularly, but not exclusively, to methods of operating mobile communications networks and to mobile telephones for use with mobile communications networks, and more particularly to remote selection of a menu function of such mobile telephones.

In accordance with a first aspect of the present invention there is provided a telephone comprising control means arranged to respond to receipt of a predetermined command signal from a communications network by entering a menu function of that telephone.

The control means may be further arranged to respond to menu and submenu selection data in said predetermined command signal to enter a corresponding submenu of the menu function.

When the predetermined menu function is a telephone directory function, the control means may be arranged to display a telephone number received in said predetermined command signal from the communications network.

The predetermined menu function may be an add entry function of the telephone directory function.

Preferably, the control means is arranged to receive from the network data indicative of a name for use in adding an entry to the telephone directory.

More preferably, the control means is arranged to retrieve said data indicative of a name from said predetermined command signal.

Alternatively, the control means is arranged to send an acceptance signal upon user activation of the add entry function, and to retrieve said data indicative of a name from a separately received command signal.

The control means may be further responsive to receipt of the predetermined command signal to ascertain whether the most recent call had been made by retrieving an entry from the telephone directory, and, if the most recent call had been so made, the predetermined menu function is an edit function of the telephone directory function.

In accordance with a second aspect of the present invention there is provided a telephone having control means responsive to an incoming call to retrieve a calling line identity from signalling data of the incoming call, to compare the retrieved calling line identity with telephone number entries of a telephone book of the telephone, and if there is no match to select a menu function for adding a new entry to the telephone book, and to offer to a user of the telephone that retrieved calling line identity as a new entry.

Preferably, the control means is further responsive to retrieve name data from the signalling data and to offer to the user that retrieved name data in association with the new entry.

The control means may be further responsive to send a request message to its network for the supply of a name associated with that calling line identity, to retrieve name data from a response message from the network and data and to offer to the user that retrieved name data in association with the new entry.

An advantage of the present invention is that the network anticipates the calling user's most likely next action and commands the telephone to enter a corresponding menu function, without requiring any input, e.g. key presses, by the calling user. This simplifies and minimises the actions required of the user.

The present invention is particularly beneficial in mobile networks, wherein users' mobile telephones have a menu system which is navigated by key presses.

Specific embodiments of a mobile communications network and of a mobile telephone for use with that network will now be described by way of example with reference to the drawings in which:

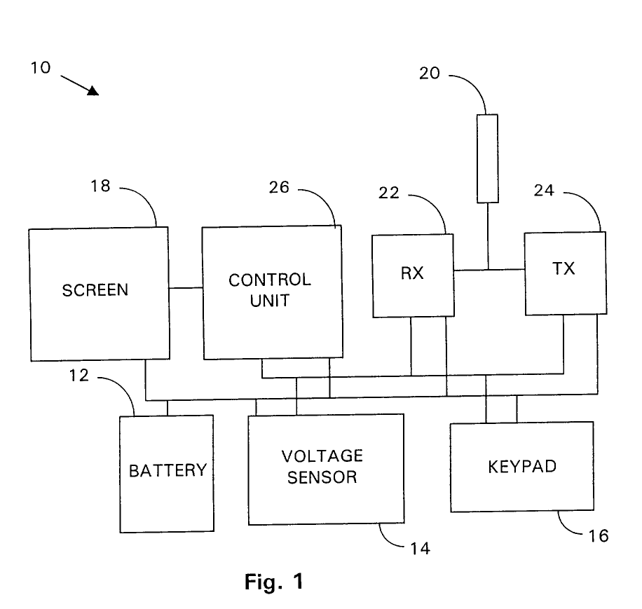

FIG. 1 is a schematic diagram of a mobile telephone in accordance with the present invention;

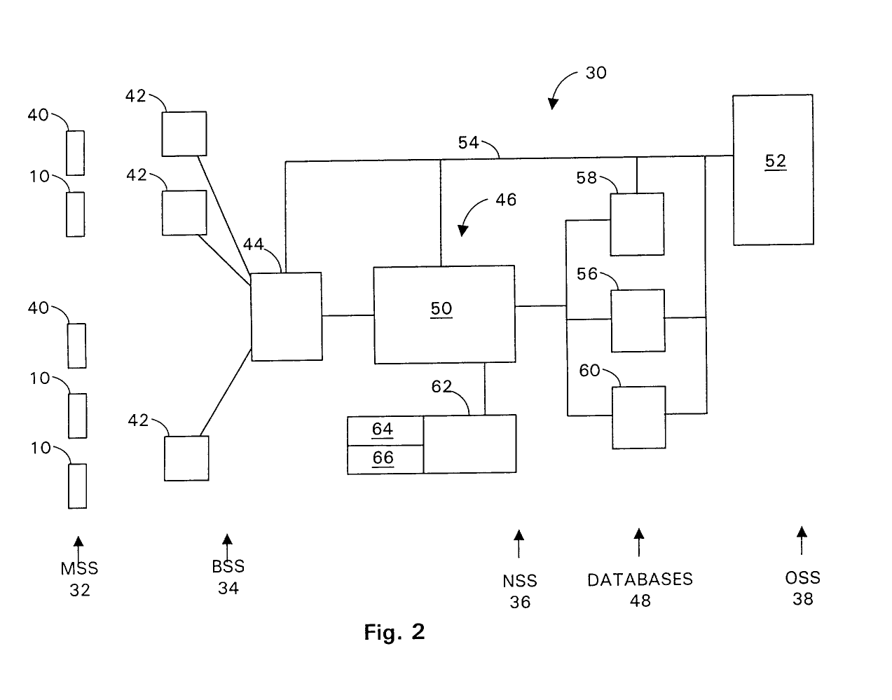

FIG. 2 is a schematic diagram of a mobile communications network for use with the mobile telephone of FIG. 1; and

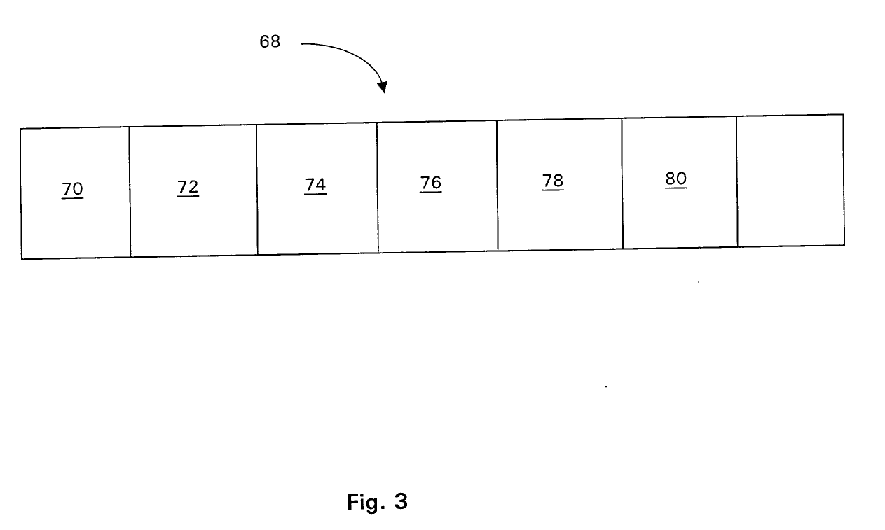

FIG. 3 is a schematic diagram of a user profile for use in the communications network of FIG. 2.

In this description the following acronyms are used:

BSS—Base Switching Subsystem

CLI—Calling Line Indication, also known as Calling Line Identity,

GPRS—General Packet Radio Service

GSM—Global System for Mobile Communications (Groupe Speciale Mobile)

HLR—Home Location Register

IVR—Interactive Voice Response

LCD—Liquid Crystal Display

MSS—Mobile Switching Subsystem

NSS—Network Switching Subsystem

OSS—Network Switching Subsystem

SMS—Short Message System

VLR—Visitor Location Register

In FIG. 1 there is shown a mobile telephone 10 of the present invention having components including a battery 12, a battery voltage sensing circuit 14, a keypad 16, an LCD screen 18, an aerial 20, a receive circuit 22, a transmit circuit 24 and a control unit 26.

The control unit 26 is arranged to receive inputs from the keypad 16, the sensing circuit 14, and the receive circuit 22, and to provide outputs to the screen 18 and the transmit circuit 24. It is arranged to provide mobile telephony functions as is known in the art, such as sending and receiving calls and messages, and managing a menu, including a telephone directory, also known as a phone book, and is further arranged in accordance with the present invention to provide additional functions as described below.

The control unit 26 is arranged to respond to receipt via the receive circuit 22 of various command signals from a host GSM network (FIG. 2) to enter its menu system and activate particular submenu functions, thereby enabling a user to make keyboard entries for those submenu functions without any manual selection procedure.

As is known in the art, a typical menu system comprises the main menu functions: Phone Book; Messages; Call Register; Settings; Call Divert; Games; Calculator; Clock and Tones. Each main menu function has a plurality of submenu functions. For example, Phone Book includes the submenu functions Search; Add Entry; Erase; Edit; etc.: Messages includes the submenu functions Inbox; Outbox; Write Messages; etc: and Call Register includes the submenu functions Missed Calls; Received Calls; Dialled Calls; etc. Some of the submenu functions themselves have submenu functions.

Before example scenarios are described, it is appropriate to describe first the SM network of FIG. 2.

In FIG. 2, there is shown a GSM network 30 constituted by four subsystems, namely, Mobile Station Subsystem (MSS) 32, Base Station Subsystem (BSS) 34, Network and Switching Subsystem (NSS) 36 and Operation Subsystem (OSS) 38. Global communications is achieved by interconnection of spaced apart national-based GSM networks operated by different respective network operators.

The GSM system is well known to the skilled person in the art and is described below only in high-level detail. However, should any reader require more information, he will find a number of publications on GSM, particularly, “The GSM System for Mobile Communications” by M. Mouly and M. -B. Pautet, ISBN 2-9507190-0-7, published 1992 by the authors thereof.

The MSS 32 comprises a plurality of the mobile telephones 10, and, until 100% penetration of the mobile telephone market by mobile telephones 10, there will be a plurality of conventional mobile telephones 40, i.e. those not having the additional feature of the present invention.

The BSS 34 comprises a plurality of base transceiver stations 42 and a plurality of base station controllers 44, only one which is shown. Each of the base station controllers 44 is connected to the NSS 36 and to a plurality of the base transceiver stations 42.

The NSS 36 comprises an exchange system 46 and user and terminal equipment databases 48. The exchange system 46 comprises a plurality of interconnected mobile services switching centres 50, only one which is shown, which are connected to the user and terminal equipment databases 48.

The OSS 38 comprises an operation and maintenance centre 52 which is connected, via a data network 54, to the BSS 34 and the NSS 36.

The user and terminal equipment databases 58 comprise a home location register (HLR) 56, a visitor location register (VLR) 58 and an equipment identity register 60.

A Voicemail system 62 is connected to the exchange system 46 and includes an interactive voice response facility (IVR) 64 capable of generating selected announcements, and a speech to text converter 66.

The HLR 56 is a database which stores user profiles 68 (FIG. 3), which contain user-specific information relevant to the provision of telecommunications services and identifying whether a given teleservice or bearer service can be provided for a user, and also containing user preferences defining how the user wishes the network to handle calls.

The VLR 58 temporarily stores subscription data for users who are normally registered with a different home GSM network and who are currently registered with the GSM network 30, i.e. under a roaming arrangement.

The user profiles 68 include a Delivery Mode field 70 containing a flag which, when set, is indicative that the GSM network had received from a mobile telephone 10 associated with the corresponding user a message addressed to a predetermined destination address and containing a unique code for notifying that network that the delivery mode for calls to that called user is to be “Message Only” mode, also referred to as restricted delivery mode. That notification message is sent either automatically by the mobile telephone when it enters low battery condition, or when the user has selected Message Only mode, e.g. from the menu. If the Delivery Mode flag is not set, the delivery mode is referred to as unrestricted delivery mode.

A mobile telephone which can send such a notification message when it enters low battery condition, and a variant mobile telephone which, when it enters low battery condition, can switch automatically, or be manually switched, between full and simplex operation, are disclosed in our co-pending European patent application number 00302738.0, filed on Mar. 31, 2000. It is not part of the present invention and will not be described further. It is sufficient for the purposes of the present invention to understand that a user profile 68 can be interrogated in the usual manner to ascertain how a call for that user should be processed, and that retrieval of the state of the Delivery Mode flag (field 70) is just one of the retrievable data items. The user profile 68 employed by the GSM network 30 has a universal user profile configuration. In other words, some profile fields are not relevant to certain types of mobile telephone, and in such a case the flags in those fields will be permanently in their reset state. In variants, the network is arranged to work with two or more types of user profiles, e.g. one type of profile will not have a Delivery Mode field 70, whilst another type of profile will have such a Delivery Mode field 70. Herein, the flag contained in the Delivery Mode field 70 is also referred to as the Delivery Mode flag.

The NSS 36 is arranged to respond to an incoming call having the above mentioned predetermined destination address by retrieving the message content of that incoming call. Upon recognising the retrieved message as the above mentioned unique code representative of the “Message Only” mode, also referred to as restricted delivery mode, the NSS 36 accesses the user profiles 68 in accordance with a source telephone number (calling line identity) retrieved from the incoming call, finds the corresponding user profile and changes its Delivery Mode flag from its reset state to its set state.

In a first scenario, a calling user, also referred to as a caller, having a mobile telephone 10 originates a call and the NSS 36 responds to that originating call by accessing the user profile 68 associated with the called number, and ascertaining, inter alia, the state of the Delivery Mode flag.

If the Delivery Mode flag in that user profile is in its set state, the NSS 36 checks the user's preferences (in fields 72, 74 of the profile) and, if this service feature, i.e. receipt of a Short Message System (SMS) message whilst in Message Mode, has not been deselected by that called user, sends an announcement selection signal to the Voicemail system 62 for generating by the IVR 64 the selected announcement, “The number you have called is in Pager Mode. You may speak a short message or key a text message.”, and also sends to that calling mobile telephone 10 a predetermined command signal.

The Short Message System technology is well known in the art and will not be described further.

The NSS 36 has also retrieved the caller's CLI and accesses the caller's profile to retrieve from an equipment identifier field 76 data indicative of the make and model of the telephone currently registered to the caller. The NSS 36 refers to a mapping table stored in the HLR 56, which maps that telephone to its menu structure type, and retrieves a type identifier. Using that type identifier, the NSS 36 now accesses the corresponding menu structure table, also stored in the HLR 56, in accordance with a Write Messages identifier to retrieve a numeric sequence command code, e.g. “23”. The NSS 36 now constructs a command signal containing that sequence and a universal command code for commanding the control unit to enter its menu system, and sends it to the caller's telephone 10. This command signal constitutes a predetermined control code of the present invention.

The control unit 26 in the caller's telephone 10 is arranged for direct control by such a received command signal, and responds to receipt of that command signal by automatically selecting the Write Message submenu function of the Messages function. This converts the keypad 16 of the caller's mobile telephone 10 from numeric entry to alpha entry, in preparation for any text message that might be entered by the caller. It will be appreciated that the caller's telephone 10 has been commanded to enter its menu system; to select the Message function, which for that particular telephone is in second position in the main menu; and to select the Write Message function, which is in third position in the Message submenu. This is known in the art as accessing a menu function by its shortcut, but the previously known use of the shortcut has been only by user input via the key pad of the telephone.

If the caller had been using a telephone having a different menu structure, the NSS 36 would have been directed by the mapping tables to the appropriate menu structure table, and would have constructed a corresponding command signal containing the universal command code and a different numeric sequence for entering the same Write Messages function.

Now that the caller's mobile telephone 10 has been automatically switched into Write Message submenu function, the keypad is immediately available for the caller to use to create a text message. When he has finished creating the text message, he sends the message by selecting Options, and then Send. In a variant, the control unit 26 responds to the first key press by offering the Send function under a select soft key, so that when the caller has completed the message he sends it by means of a single press of the select soft key. In another variant, the control unit 26 the NSS 36 responds to the first key press by transmitting a code signal to the network indicating that the user has started to compose an SMS message, and the NSS 36 responds to this code signal by sending a further command signal to control the telephone to offer the Send function under the select soft key.

If the caller decides not to compose an SMS message but to speak a message instead, this is received by the IVR 64 and passed to the speech to text converter 66 to be converted into the appropriate format to be sent to the called number as an SMS message.

The NSS 36 receives the text message sent by the caller, or the text message output from the speech to text converter 66 should the caller not have availed himself of the immediate use of the Write Messages submenu function and spoken a message instead, and generates an SMS message and sends that to the called number.

In a second scenario, a user might have changed his network number for some reason. If a caller originates a call to the previous number, the NSS 36 accesses the user profiles in the usual manner, finds from the retrieved profile that the called user has a new network number, and that there is no prohibition on the release of that new network number, e.g. that a Restricted Number flag 78 or a Number Withheld flag 80 is not in its set state. In these circumstances, in addition to automatically routing that call to the new network number, the NSS 36 first accesses the mapping tables as described above in the first scenario to retrieve a numeric sequence corresponding to Number Entry, sends an announcement selection signal to the Voicemail system 62 for generating by the IVR 64 the selected announcement, “Your call is being connected. Please note that the called party has a new number which is being sent to you”, and also generates and sends to that calling mobile telephone 10 a Phone Book Update command signal, constituting a predetermined command signal of the present invention.

The Phone Book Update command signal contains the universal code for commanding the control unit 26 to enter its menu system, the numeric sequence “13”, which selects the Phone Book function followed by the Add Entry submenu function, a second code for commanding a number entry part as opposed to a name entry part, and the new network number. In variants, the control unit 26 is arranged to select automatically the number entry part of the Add Entry submenu function in response to receipt of the predetermined command signal, regardless of whether that predetermined command signal contains that second code.

The control unit 26 does not immediately enter the Add Entry submenu function upon receipt of the Phone Book Update command signal, but performs a preliminary check to ascertain whether the original call had been made after selection from its Phone Book. If not, then it will provide a display for the entry of a number as part of the Add Entry submenu function and display in the text box of that display the new network number. If the caller wishes to add this number as a new entry to his Phone Book he presses a Navigator Key whose text is now reading “OK”.

The control unit 26 responds to that manual command by sending a message to the GSM network 30 indicative of the caller's acceptance of the offer to add that new number to his Phone Book. In response, the NSS 36 sends a Add Entry command signal, constituting a further predetermined command signal of the present invention, containing the name of the called party and a code for commanding control unit 26 to select the part of the Add Entry submenu function which displays a text box for the entry of a name, if it is not already doing so, and to display in the text box of that display the name of the called party. In a variant, the name of the called party is sent in the Phone Book Update command signal, and stored by the control unit 26 in readiness for use in this procedure.

If the caller wishes to add the offered name he presses a Navigator Key whose text is now reading “OK”. Otherwise he can cancel the displayed name and enter his own text. Alternatively, he can accept the offered name and then edit it using the Edit submenu function of the Phone Book.

If the preliminary check ascertains that the original call had been made after selection from its Phone Book, the control unit 26 will know, by means of the Dialled Numbers submenu function of its Call Register function, the particular Phone Book entry, and instead of responding to the Phone Book Update command signal by switching to the Add Entry submenu function, now responds by entering the Edit submenu function of the Phone Book, automatically selecting that particular Phone Book entry and displaying the received new network number instead of the existing number of that particular Phone Book entry. The Navigator Key text will now read “OK”, and the caller can accept the offered number by pressing the Navigator Key.

In a variation of this second scenario, the control unit is programmed to compare the CLI of an incoming call with the entries of the phone book (this is a known act for displaying the stored name of a matching entry) and if there is no matching entry it will send a request message to the network for a name associated with that CLI. This name can be the surname in the account details of the calling user, or it can be retrieved from a user-name field of the user's profile, if the calling user has previously supplied a name This might be his preferred name, which might be a nickname or any other name different from the account surname.

When the called user ends the call, the control unit 26 now automatically selects the Add Entry function and enters the received data. This can be the number entry part first, followed by the name part, or the other way around. The called user can now choose to make a new entry in the same way as described above.

Whereas in the above described embodiment the network 30 is a GSM network, it will be appreciated that this is not a limiting factor of the present invention and that the network 30 could equally well be a General Packet Radio Service (GPRS) network.

Unless the context clearly requires otherwise, throughout the description and the claims, the words “comprise”, “comprising” and the like are to be construed in an inclusive as opposed to an exclusive or exhaustive sense; that is to say, in the sense of “including, but not limited to”.

1. A telephone comprising control means arranged to respond to receipt of a predetermined command signal from a communications network by entering a menu function of that telephone.

2. A telephone as claimed in claim 1, wherein the control means is further arranged to respond to menu and submenu selection data in said predetermined command signal to enter a corresponding submenu of the menu function.

3. A telephone as claimed in claim 1, wherein the predetermined menu function is a telephone directory function, and wherein the control means is arranged to display a telephone number received in said predetermined command signal from the communications network.

4. A telephone as claimed in claim 3, wherein the predetermined menu function is an add entry function of the telephone directory function.

5. A telephone as claimed in claim 4, wherein the control means is arranged to receive from the network, data indicative of a name for use in adding an entry to the telephone directory.

6. A telephone as claimed in claim 5, wherein the control means is arranged to retrieve said data indicative of a name from said predetermined command signal.

7. A telephone as claimed in claim 5, wherein the control means is arranged to send an acceptance signal upon user activation of the add entry function, and to retrieve said data indicative of a name from a separately received command signal.

8. A telephone as claimed in claim 3, wherein the control means is further responsive to receipt of the predetermined command signal to ascertain whether the most recent call had been made by retrieving an entry from the telephone directory, and, if so, the predetermined menu function is an edit function of the telephone directory function.

9. A telephone having control means responsive to an incoming call to retrieve a calling line identity from signalling data of the incoming call, to compare the retrieved calling line identity with telephone number entries of a telephone book of the telephone, and if there is no match to select a menu function for adding a new entry to the telephone book, and to offer to a user of the telephone that retrieved calling line identity as a new entry.

10. A telephone as claimed in claim 9, wherein the control means is further responsive to retrieve name data from the signalling data and to offer to the user that retrieved name data in association with the new entry.

11. A telephone as claimed in claim 9, wherein the control means is further responsive to send a request message to its network for the supply of a name associated with that calling line identity, to retrieve name data from a response message from the network and data and to offer to the user that retrieved name data in association with the new entry.

12. A telephone as claimed in claim 1 and substantially as herein described with reference to FIG. 1 of the drawings.

13. A telephone as claimed in claim 9 and substantially as herein described with reference to the drawings.
